(19) United States
(12) Patent Application Publication
(10) Pub. No.: US 2009/0172246 A1
(43) Pub. Date: Jul. 2, 2009

(54) DEVICE AND METHOD FOR MANAGING INITIALIZATION THEREOF

(75) Inventor: Itshak Afriat, Tel-Mond (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd., Kfar Saba (IL)

(21) Appl. No.: 11/964,057

(22) Filed: Dec. 26, 2007

(51) Int. Cl. G06F 12/02

(52) U.S. Cl. 711/103; 711/E12.008

(57) ABSTRACT

A host may initialize itself faster by enabling an associated storage device to respond to host access commands under specified conditions before the storage device has completed its own initialization. Embodiments of the invention include a storage device, a controller, a method of servicing commands, and a method of using a host that sends access commands to a storage device. Access commands to a flash memory use logical addresses to reference the memory contents. A controller translates the logical addresses to physical addresses using a mapping table that the controller constructs in volatile memory during initialization based on data retrieved from the flash memory. An access command satisfying a predefined condition is serviced before the controller completes the construction of the mapping table.

### BACKGROUND

In conventional systems that include flash memory storage devices and associated hosts, a storage device typically requires both loading a large amount of firmware code and constructing extensive management tables during initialization. Examples of such storage devices include USB drives and SD cards. Examples of such hosts include mobile telephones, MP3 players, and digital cameras.

In such conventional systems, the storage device must complete the tasks of building the management table and initializing itself before it can service access commands from the host. Because the host itself might be simultaneously initializing from the storage device, the host must wait a relatively long time for initialization. In some cases, if the storage device does not respond to the host access command within a given time, a timeout in the host logic aborts the initialization process.

Accordingly, for some host commands, such as those used in the initialization of the host, it would be desirable to reduce the response time of the storage device while the storage device itself is initializing.

### SUMMARY

A design approach based in part on the foregoing observations is provided to enable a storage device to respond to host access commands under specified conditions before the storage device has completed its initialization process. This way, a host can initialize itself faster. To implement this design approach, various embodiments are possible, including a storage device, a controller, a method of servicing commands, and a method of using a host that sends access commands to a storage device.

In one embodiment, a storage device is provided for servicing commands that use logical addresses to reference memory contents. Such storage device includes a flash memory and a controller. The controller is configured to translate a logical address in a command to a physical address using a mapping table that the controller constructs in volatile memory during initialization. This table is based on data retrieved from the flash memory. The controller is operative to service an access command before the controller completes the construction of the mapping table. Such access command includes a logical address, which satisfies a predefined condition.

The access command may be a read command. The read command may be from a host, and the controller may be operative to respond to the read command by transferring code from the flash memory to the host, which uses the code for initialization of the host.

In such a storage device, the initialization may occur during a power-up or a reset operation. If the initialization occurs during a reset operation, the reset operation may be a hardware or a software reset operation.

In the storage device, the controller may be further operative to disregard an access command, which does not include a logical address satisfying the predefined condition, if the construction of the mapping table has not yet completed. Alternatively, the controller may be further operative to delay servicing an access command, which does not include a logical address satisfying the predefined condition, until after completing the construction of the mapping table.

In the storage device, the logical address may satisfy the predefined condition if the logical address equals one of a set of one or more logical addresses. The predefined condition may be such that the access command satisfies it if the at least one logical address is within a predefined range. The predefined range may include logical address zero.

In another embodiment, a controller for controlling a storage device is provided. Such controller includes a volatile memory and logic circuitry. The logic circuitry is configured to receive a command with a logical address and to translate the logical address to a physical address using a mapping table, which mapping table is constructed in the volatile memory during initialization based on data that the logic circuitry retrieves from a flash memory. The logic circuitry is operative to service an access command before completing the construction of the mapping table, if the access command includes a logical address that satisfies a predefined condition.

The access command serviced by the logic circuitry may be a read command. The read command may be from a host, and the logic circuitry may be operative to respond to the read command by transferring code from the flash memory to the host, which uses the code for initialization of the host.

In such a controller, the initialization may occur during a power-up or a reset operation. If the initialization occurs during a reset operation, and the reset operation is a hardware or a software reset operation.

In the controller, the logic circuitry may be further operative to disregard an access command, which does not include a logical address satisfying the predefined condition, if the construction of the mapping table has not yet completed. Alternatively, the logic circuitry may be further operative to delay servicing an access command, which does not include a logical address satisfying the predefined condition, until after completing the construction of the mapping table.

In the controller, the logical address may satisfy the predefined condition if the logical address equals one of a set of one or more logical addresses. The predefined condition may be such that the access command satisfies it if the at least one logical address is within a predefined range. The predefined range may include logical address zero.

In yet another embodiment, a method is provided for servicing commands that use logical addresses. Such the method may include providing a controller, providing to the controller a command, and causing the controller, in response thereto, to service the command. The controller provided is operative to service commands that use logical addresses to reference contents of a flash memory, and to translate logical addresses to physical addresses, which translation uses at least one mapping table that the controller constructs in volatile memory during initialization based on data retrieved from the flash memory. The command provided to the controller includes a logical address, which address satisfies a predefined condition. The controller is caused to service the command before the controller completes the construction of the at least one mapping table.

In this method of servicing commands, the initialization may occur during a power-up or a reset operation. If the initialization occurs during a reset operation, the reset operation may be a hardware or a software reset operation.

For this method, the command provided to the controller may be a read command. The read command may be provided from a host, and the controller may be caused to respond to the read command by transferring code from the flash memory to the host, which uses the code for initialization of the host.

This method of servicing commands may further comprise causing the controller to disregard an access command, which does not include a logical address satisfying the predefined condition, if the construction of the mapping table has not yet completed. Alternatively, the method may further comprise causing the controller to delay servicing an access command, which does not include a logical address satisfying the predefined condition, until after completing the construction of the mapping table.

The logical address may satisfy the predefined condition of the method of servicing commands if the logical address equals one of a set of one or more logical addresses. The predefined condition may be such that the access command satisfies it if the at least one logical address is within a predefined range. The predefined range may include logical address zero.

Another method may be provided for using a host that sends access commands to a storage device. This method may include providing a storage device with a controller, transferring from a host to the controller a command, and causing the controller, in response thereto, to service the command before the controller completes the construction of the at least one mapping table. The controller provided with the storage device is operative to service commands that use logical addresses to reference contents of a flash memory, and to translate logical addresses to physical addresses, which translating uses at least one mapping table that the controller constructs in volatile memory during initialization based on data retrieved from the flash memory. The command transferred from the host to the controller includes a logical address, which address satisfies a predefined condition. The controller is caused to service the command before the controller completes the construction of the at least one mapping table.

In this method of using a host, the initialization may occur during a power-up or a reset operation. If the initialization occurs during a reset operation, the reset operation may be a hardware or a software reset operation.

For this method, the command provided to the controller may be a read command. The controller may be caused to respond to the read command by transferring code from the flash memory to the host, which uses the code for initialization of the host.

Also, this method of using a host may further comprise causing the controller to disregard an access command, which does not include a logical address satisfying the predefined condition, if the construction of the mapping table has not yet completed. Alternatively, the method may further comprise causing the controller to delay servicing an access command, which does not include a logical address satisfying the predefined condition, until after completing the construction of the mapping table.

The logical address may satisfy the predefined condition of this method of using a host if the logical address equals one of a set of one or more logical addresses. The predefined condition may be such that it is satisfied if the at least one logical address of the command provided to the controller is within a predefined range. The predefined range may include logical address zero.

These and other embodiments, features, aspects and advantages thereof will become better understood from the description herein, appended claims, and accompanying drawings as hereafter described.

### BRIEF DESCRIPTION OF THE DRAWINGS

The accompanying drawings, which are incorporated in and constitute a part of this specification illustrate various aspects of the various embodiment and, together with the description, serve to explain them in greater detail, wherein:

FIG. 1 represents an embodiment of a storage device for a host;

FIGS. 2(a)-2(c) portray data structures that represent messages sent via a NAND-based interface from a host to a storage device in accordance with one embodiment of the storage device;

FIG. 3 portrays data structures that represent messages sent via an MMC-based interface from a host to a storage device in accordance with an alternate embodiment of the storage device; and

FIG. 4 presents a flow chart representing a method of servicing commands according to yet another alternate embodiment of the invention.

### DETAILED DESCRIPTION

The claims below will be better understood by referring to the detailed description of the various embodiments. This description is not intended to limit the scope of claims but instead to further explain the design principles and the various embodiments that implement them. Examples of the various embodiments include a storage device for a host, a controller for the storage device, a method for servicing commands that use logical addresses, and a method of using a host that sends access commands to a storage device.

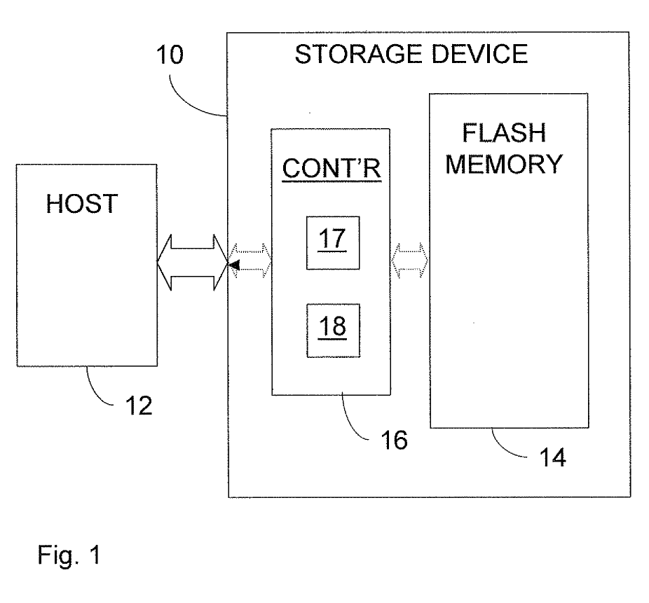

With reference to FIG. 1, one embodiment is a storage device 10 for a host 12, which sends access commands to the storage device 10 using logical addresses to reference memory contents. The storage device includes a flash memory 14 and a controller 16. The controller 16 translates logical addresses in host commands to physical addresses. For this translation, the controller 16 uses one or more mapping tables. The controller 16 has logic circuitry 17 to construct the mapping table in its own volatile memory (RAM) 18 during initialization based on data retrieved from the flash memory 14. The initialization referenced herein can occur during power-up or reset operations. The reset operations may be either hardware reset operations or software reset operations.

If an access command has a logical address that satisfies a predefined condition, the controller 16 can service the access command before completing the construction of the mapping tables. The predefined condition may be based on at least one logical address, for example, a condition where the logical address is within a predefined range. In one embodiment, the predefined range includes logical address zero. The controller can service a variety of access commands, such as read commands, a write commands and erase commands.

For access commands, which have logical addresses that satisfy the predefined condition, the controller 16 does not need to construct mapping tables because of information programmed into firmware that resides in the flash memory 14. (In alternate embodiments, the firmware may reside in the ROM of the controller. In accordance with further alternate embodiments, the controller itself, and in turn its ROM, may be an integral part of the flash memory structure.) This firmware directs the controller 16 to contents of the flash memory 14, which correspond to the logical address of the access command. For example, if the predefined condition is that the logical address of an access command equals logical address zero, the firmware of the controller is designed to immediately service a host request involving logical address zero by retrieving data from a predetermined physical address of the flash memory 14. The firmware thus associates the logical address zero with the proper physical address in the flash memory 14 and does not need the mapping table for that purpose.

In some embodiments the association of the logical address satisfying the predefined condition with a corresponding physical address from which the host access is served may be fixed in advance. For example physical block 100 may always be the physical address from which accesses of the host to logical address 0 are serviced. In other embodiments this is not necessarily the case. For example, NAND flash memory devices typically have some bad physical blocks even at the time of shipment to customers. In such flash memory devices it is not possible to guarantee that a specific physical block (such as physical block 100) will always be available. Therefore some embodiments of the present invention use a logical-to-physical address association that is not fixed in advance but is determined after it is known which physical blocks are bad. In such embodiments it is the case that two similar memory devices responding to the same logical address satisfying the predetermined condition will use two different physical addresses for servicing the request. It is even possible that the same storage device will use two different physical addresses at different points in time, for example if the storage device is reformatted and reconfigured between the two points in time.

In the embodiment of FIG. 1, the controller 16 responds to host commands by providing code from the flash memory 14 to the host 12 to initialize the host 12. That is, the storage device 10 is configured so that the time duration for initializing the host 12 and the time duration for initializing the storage device 10 may overlap substantially. Thus, this configuration is suitable for flash memory devices, for example USB drives and SD cards, that have to load large amounts of firmware code on power-up and must also perform long initializations of management tables. Accordingly, a host, which boots itself from a flash memory, does not need to wait as long before it can initialize itself.

In this embodiment, if the storage device 10 receives an access command that has a logical address that does not satisfy the predefined condition before the controller 16 has completed constructing the mapping table, the controller 16 disregards the access command. In an alternate embodiment, the controller 16 delays servicing the access command until after constructing the mapping table.

The controller in this embodiment is designed to have a volatile memory (RAM) and logic circuitry, which is configured to translate logical addresses in access commands to physical addresses.

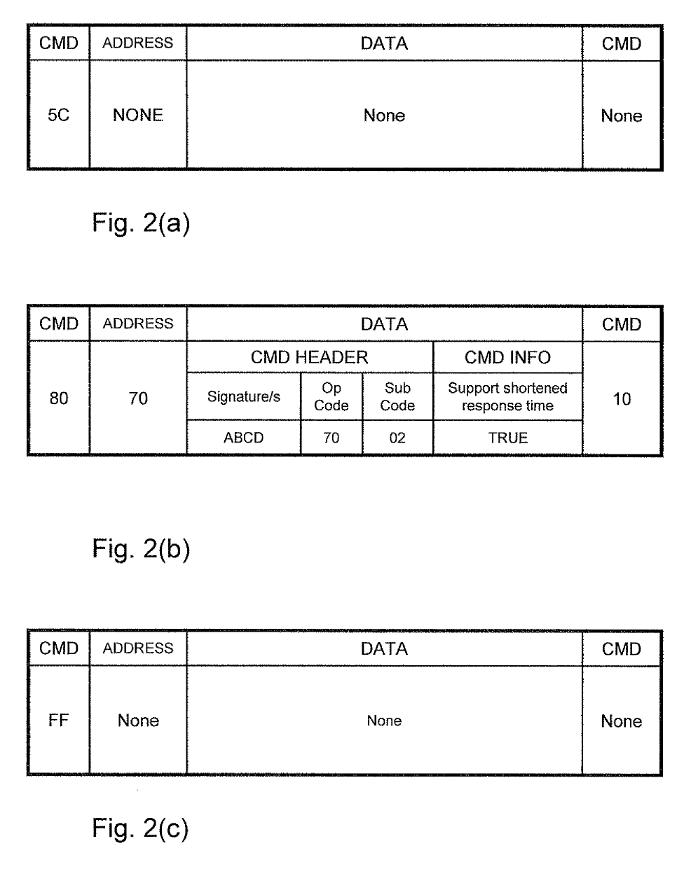

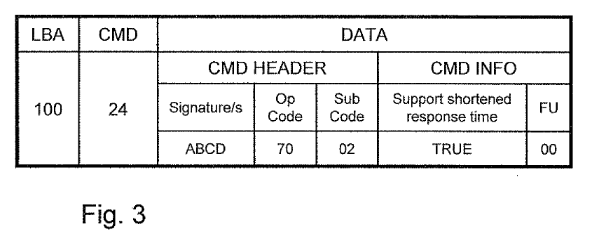

In order for a host to initialize from a storage device using the methods of the present invention, the storage device must first be configured to store the host's boot code and to store it in a way that it is associated with a logical address satisfying the predetermined condition. Example data structures are illustrated in FIGS. 2-3 for messages that are sent to a storage device to enable faster initialization. The data structures shown in FIGS. 2(a) through 2(c) represent messages sent via a NAND-based interface to a storage device, and the data structure illustrated in FIG. 3 represents a message sent via an MMC-based interface. Although not illustrated here, other data structures are possible.

For the NAND-based interface, FIG. 2(a) illustrates the data structure of a command that is sent only once in the lifetime of the storage device. In one scenario, at the completion of the manufacture of the storage device, a designated host in the factory may provide the command. As shown in the illustration, the host first sends a unique command, having a prefix “5C” (the first “CMD” field) in this example, to notify the controller of the storage device that the next command will be a configuration command. This initial command specifies no address (“ADDRESS”), data (“DATA”), or suffix (the second “CMD”). After the storage device processes this initial command, it indicates that it is ready for the next command by setting the “ready/busy” signal to “ready.”

Then, as represented in FIG. 2(b), the host in the factory sends a special type of write command, which is another command that is sent only once in the lifetime of the storage device. The write command, having a prefix “80” and a suffix “10,” specifies a logical address (“ADDRESS”) and the data (“DATA”) to be associated with it, typically the boot code to be provided to a host. This command directs the controller to create and store an association of the logical address with the physical address, wherein the storage device stores the host boot code. The data sent within the special write command comprise a command header (“CMD HEADER”) and command information (“CMD INFO”). The command header specifies a signature (“Signature/s”), an operation code (“Op Code”), and a subsequent code (“Sub Code”), which in this example are “ABCD,” “70,” and “02,” respectively. Both the operation code and the subsequent code identify the command to the controller as related to the shortened response time feature. The special write command sets to “true” a flag that enables the shortened response time feature (“Support shortened response time”). After the storage device processes this write command, it indicates that it is ready for the next command by setting its “ready/busy” signal to “ready.”

The host in the factory then sends a reset command as represented in FIG. 2(c). This command, with the prefix “FF” (the first “CMD” field), is required to prepare the storage device for regular operation. This command specifies no address (“ADDRESS”), data (“DATA”), or suffix (the second “CMD”). After the storage device processes the reset command, it indicates that it is ready for the next command by setting the “ready/busy” signal to “ready.” At this point, the storage device is configured to respond during initialization with a shortened response time.

The methods of the present invention can be used with NAND devices that support built-in logical-to-physical address translation within their controllers, such as the flash storage devices of U.S. patent application Ser. No. 11/326,336 to Lasser.

Regarding the MMC-based interface, FIG. 3 illustrates the data structure of a write command that a factory host sends to the storage device to activate the shortened response time feature. In the write command the host specifies a logical block address (“LBA”), which is “100” in this example, although another address may be chosen. Then, the command value (the “CMD” field) “24” identifies the command to the storage device as a write command. The command then specifies the data (“DATA”), which directs the controller to create and store an association of the logical address with the physical address, wherein the storage device stores the host initialization code. The data sent within the write command comprise a command header (“CMD HEADER”) and command information (“CMD INFO”) with the same values as that of the example presented above for a NAND-based interface. After the storage device processes the special write command, it indicates that it is ready for the next command by setting the “ready” signal. At this point, the storage device is configured to respond when initializing with a shortened response time.

Another embodiment is a method of servicing commands that use logical addresses. The command may be of many types, such as read commands, write commands, and erase commands. The method may be executed during an initialization that occurs during a power-up or a reset operation. If the initialization occurs during a reset operation, the reset operation may be a hardware reset operation or a software reset operation.

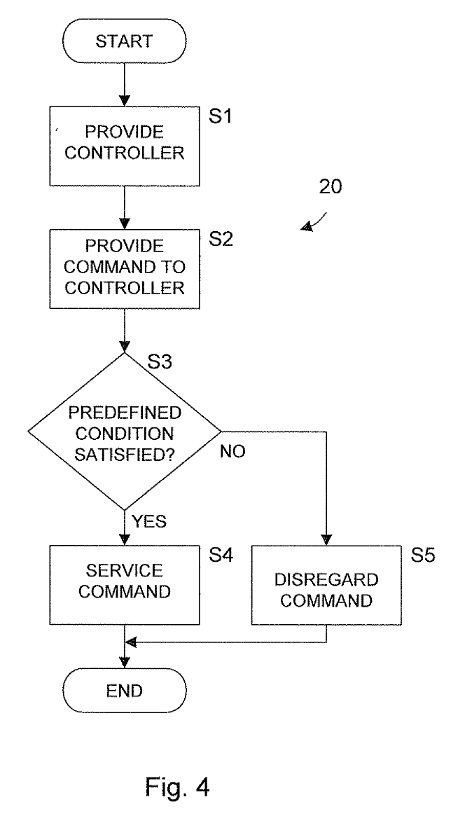

With reference to the flow chart 20 in FIG. 4, the method begins by providing a controller that can: (1) service commands that use logical addresses to reference contents of a flash memory; and (2) translate logical addresses to physical addresses using at least one mapping table that the controller constructs in volatile memory (RAM) during initialization based on data retrieved from the flash memory. [Step S1.] Then, a host provides to the controller a command that includes a logical address. [Step S2.] The controller tests whether the logical address satisfies a predefined condition. [Step S3.] If the logical address satisfies the predefined condition, the controller services the command, even if the controller has not yet completed the construction of the mapping tables. [Step S4.] Thus, even while the controller is initializing, it can respond to a command, such as a read command, from a host that is also initializing, by providing code from the flash memory to power up the host.

If the logical address of the access command does not satisfy the predefined condition before completion of the construction of the mapping table, the controller disregards the command. [Step S5.] In an alternate embodiment, if the logical address of the access command does not satisfy the predefined condition, the controller delays servicing the access command until after completing the construction of the mapping table.

Having thus described the foregoing exemplary embodiments it will be apparent to those skilled in the art that various equivalents, alterations, modifications, and improvements thereof are possible without departing from the scope and spirit of the claims as hereafter recited. Accordingly, the claims are not limited to the foregoing discussion.

I claim:

1. A storage device for servicing commands that use logical addresses to reference memory contents, the storage device comprising:
a flash memory; and
a controller configured to translate a logical address in a command to a physical address using a mapping table that the controller constructs in volatile memory during initialization based on data retrieved from the flash memory,
wherein the controller is operative to service an access command before the controller completes the construction of the mapping table, the access command including a logical address satisfying a predefined condition.

2. The storage device of claim 1, wherein the initialization occurs during a power-up or a reset operation.

3. The storage device of claim 2, wherein the initialization occurs during a reset operation, and the reset operation is a hardware or a software reset operation.

4. The storage device of claim 1, wherein the access command is a read command.

5. The storage device of claim 4, wherein the read command is from a host, and the controller is operative to respond to the read command by transferring code from the flash memory to the host, which uses the code for initialization of the host.

6. The storage device of claim 1, wherein the controller is further operative to disregard an access command, which does not include a logical address satisfying the predefined condition, if the construction of the mapping table has not yet completed.

7. The storage device of claim 1, wherein the controller is further operative to delay servicing an access command, which does not include a logical address satisfying the predefined condition, until after completing the construction of the mapping table.

8. The storage device of claim 1, wherein the logical address satisfies the predefined condition if the logical address equals one of a set of one or more logical addresses.

9. The storage device of claim 8, wherein the access command satisfies the predefined condition if the at least one logical address is within a predefined range.

10. The storage device of claim 9, wherein the predefined range includes logical address zero.

11. A controller for controlling a storage device, the controller comprising:
a volatile memory; and
logic circuitry configured to receive a command with a logical address and to translate the logical address to a physical address using a mapping table, which mapping table is constructed in the volatile memory during initialization based on data that the logic circuitry retrieves from a flash memory,
wherein the logic circuitry is operative to service an access command before completing the construction of the mapping tables if the access command includes a logical address that satisfies a predefined condition.

12. The controller of claim 11, wherein the initialization occurs during a power-up or a reset operation.

13. The controller of claim 12, wherein the initialization occurs during a reset operation, and the reset operation is a hardware or a software reset operation.

14. The controller of claim 11, wherein the access command is a read command.

15. The controller of claim 14, wherein the read command is from a host, and the logic circuitry is operative to respond to the read command by transferring code from the flash memory to the host, which uses the code for initialization of the host.

16. The controller of claim 11, wherein the logic circuitry is further operative to disregard an access command, which does not include a logical address satisfying the predefined condition, if the construction of the mapping table has not yet completed.

17. The controller of claim 11, wherein the logic circuitry is further operative to delay servicing an access command, which does not include a logical address satisfying the predefined condition, until after completing the construction of the mapping table.

18. The controller of claim 11, wherein the logical address satisfies the predefined condition if the logical address equals one of a set of one or more logical addresses.

19. The controller of claim 18, wherein the access command satisfies a predefined condition if the at least one logical address is within a predefined range.

20. The controller of claim 19, wherein the predefined range includes logical address zero.

21. A method of servicing commands that use logical addresses, the method comprising:
providing a controller operative to
service commands that use logical addresses to reference contents of a flash memory, and
translate logical addresses to physical addresses, which translation uses at least one mapping table that the controller constructs in volatile memory during initialization based on data retrieved from the flash memory;
providing to the controller a command that includes a logical address, which address satisfies a predefined condition; and
causing the controller, in response thereto, to service the command before the controller completes the construction of the at least one mapping table.

22. The method of claim 21, wherein the initialization occurs during a power-up or a reset operation.

23. The method of claim 22, wherein the initialization occurs during a reset operation, and the reset operation is a hardware or a software reset operation.

24. The method of claim 21, wherein the command provided to the controller is a read command.

25. The method of claim 24, wherein the read command provided to the controller is from a host, the method further comprising:
causing the controller to respond to the read command by transferring code from the flash memory to the host, which uses the code for initialization of the host.

26. The method of claim 21, further comprising:
causing the controller to disregard an access command, which does not include a logical address satisfying the predefined condition, if the construction of the mapping table has not yet completed.

27. The method of claim 21, further comprising:
causing the controller to delay servicing an access command, which does not include a logical address satisfying the predefined condition, until after completing the construction of the mapping table.

28. The method of claim 21, wherein the logical address satisfies the predefined condition if the logical address equals one of a set of one or more logical addresses.

29. The method of claim 28, wherein the command provided to the controller satisfies a predefined condition if the at least one logical address is within a predefined range.

30. The method of claim 29, wherein the predefined range includes logical address zero.

31. A method of using a host that sends access commands to a storage device, the access commands using logical addresses, the method comprising:
providing a storage device with a controller, the controller being operative to
service commands that use logical addresses to reference contents of a flash memory, and
translate logical addresses to physical addresses, which translating uses at least one mapping table that the controller constructs in volatile memory during initialization based on data retrieved from the flash memory;
transferring from a host to the controller a command that includes a logical address, which address satisfies a predefined condition; and
causing the controller, in response thereto, to service the command before the controller completes the construction of the at least one mapping table.

32. The method of claim 31, wherein the initialization occurs during a power-up or a reset operation.

33. The method of claim 32, wherein the initialization occurs during a reset operation, and the reset operation is a hardware or a software reset operation.

34. The method of claim 31, wherein the command provided to the controller is a read command.

35. The method of claim 34 further comprising:
causing the controller to respond to the read command by transferring code from the flash memory to the host, which uses the code for initialization of the host.

36. The method of claim 31, further comprising:
causing the controller to disregard an access command, which does not include a logical address satisfying the predefined condition, if the construction of the mapping table has not yet completed.

37. The method of claim 31, further comprising:
causing the controller to delay servicing an access command, which does not include a logical address satisfying the predefined condition, until after completing the construction of the mapping table.

38. The method of claim 31, wherein the logical address satisfies the predefined condition if the logical address equals one of a set of one or more logical addresses.

29. The method of claim 38, wherein the command provided to the controller satisfies a predefined condition if the at least one logical address is within a predefined range.

40. The method of claim 39, wherein the predefined range includes logical address zero.
